(19) United States
(12) Patent Application Publication
(10) Pub. No.: US 2007/0018584 A1
(43) Pub. Date: Jan. 25, 2007

(54) Discharge bulb

(75) Inventors: Takuya Serita, Shizuoka (JP); Takeshi Fukuyo, Shizuoka (JP); Takaaki Komatsu, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/487,563

(22) Filed: Jul. 17, 2006

(30) Foreign Application Priority Data
Jul. 19, 2005 (JP) P. 2005-208040

(51) Int. Cl. H01J 61/20

(52) U.S. Cl. 313/641

(57) ABSTRACT

A discharge bulb is equipped with an arc tube in which discharge electrodes are provided face to face and a luminescent material is filled together with a starting rare gas inside a ceramic tube. A metallic pipe is jointed into the pore of a tube end communicating with a discharge light emitting chamber. The rear end of an electrode rod inserted into the pipe is jointed to the pipe and its tip protrudes into the discharge light emitting chamber. A recess is circumferentially arranged on the inner peripheral surface of the pore between the tip of the pipe and the discharge light emitting chamber. The coldest point is in the recess so that a metal halide is not gathered in the micro-space and the metal halide contributing to discharge light emission does not decrease thus obtaining a desired luminous flux.

The present application claims foreign priority based on Japanese Patent Application No. P.2005-208040, filed on Jul. 19, 2005, the contents of which are incorporated herein by reference.

### BACKGROUND OF THE INVENTION

1. FIELD OF THE INVENTION

The present invention relates to a discharge bulb equipped with an arc tube in which discharge electrodes are provided face to face and a luminescent material (such as a metal halide) is filled together with a starting rare gas inside a ceramic tube.

2. RELATED ART

As light sources for an automobile headlamp, there are discharge bulbs equipped with glass arc tubes. In this type of a discharge bulb, there are problems that a metal halide filled inside a glass tube accelerates corrosion of the glass tube so as to cause devitrification and blacking phenomena. The devitrification and blacking phenomena prevents proper light distribution. In addition, a service life of the discharge bulb is not so long.

In recent years, as shown in JP-A-2004-362978 (refer to FIG. 9), a discharge bulb has been proposed equipped with a ceramic arc tube including a discharge light emitting chamber s in which discharge electrodes are provided face to face and a luminescent material is filled together with a starting rare gas. That is, the arc tube has a structure where a molybdenum pipe 212 is jointed by metallization to a pore 201 at each end of a ceramic tube 200. The rear end of an electrode rod 214 inserted into the molybdenum pipe 212 so as to protrude its tip into (the discharge light emitting chamber s of) the ceramic tube 200 is jointed (welded) to the rear end of the molybdenum pipe 212 protruding from the ceramic tube 200. Thus, both ends of the ceramic tube 200 (that is, pores 201 communicating with the discharge light emitting chamber s) are sealed. A sign 216 represents a lead wire connected to the molybdenum pipe 212 protruding from the end of the ceramic tube 200. The ceramic tube 200 is stable against a metal halide so that a ceramic arc tube has a longer service life than a glass arc tube.

A ceramic arc tube is assembled with the electrode 214 inserted into the molybdenum pipe 212 jointed by metallization to the ceramic tube 200. Further, a thermal stress generated at the sealed part at each end of the ceramic tube 200 must be absorbed. Thus, a micro-space 215 of for example about 25 micrometers is formed between the electrode rod 214 and the molybdenum pipe 212. The molybdenum pipe 212 and the electrode rod 214 have good thermal conductivity (heat radiation). Thus, the coldest point of an illuminating arc tube (coldest point in the communicating part of the discharge light emitting chamber s) is inward from the micro-space 215 between the electrode rod 214 and the molybdenum pipe 212 (most distant area from the discharge light emitting chamber s). The problem is that the metal halide filled in the discharge light emitting chamber s is gathered and retained as vapor, a liquid or a solid matter inward from the micro-space 215 as the coldest point while the arc tube is illuminated. This results in reduced amount of metal halide substantially contributing to the discharge light emission and failure to obtain a desired luminous flux.

The inventor proposes that the coldest point of the illuminating arc tube should be moved from the end of the arc tube to the discharge light emitting chamber s in order to keep the filled metal halide out of the micro-space 215. As shown in FIG. 10, the molybdenum pipe 212 is inserted at a shallower depth into the pore 201 and a recessed groove 217 is circumferentially arranged in a space between the tip of the molybdenum pipe 212 on the inner peripheral surface of the pore 201 and the discharge light emitting chamber s. It has been demonstrated that the coldest point of the arc tube is moved toward the discharge light emitting chamber S and the filled metal halide does not stay in the micro-space 215.

As a ceramic arc tube, a frit seal structure (not shown) is also known the electrode rod 214 is inserted into the pore 201 at each end of the ceramic tube 200 via a micro-space and the protruding part of the electrode rod 214 protruding from each end of the ceramic tube 200 are glass-welded to the end of the ceramic tube 200. It has been demonstrated that, in an arc tube of the frit seal structure alike including a recessed groove 217 close to the discharge light emitting chamber s on the inner peripheral surface of the pore 201, the coldest point of the arc tube has moved toward the discharge light emitting chamber s and the filled metal halide does not stay in the micro-space. The inventor has thus made this application.

### SUMMARY OF THE INVENTION

One or more embodiments of the present invention, provide a discharge bulb that suppresses gathering of a metal halide in a micro-space on a periphery of a base end of an electrode rod inserted into a pore by moving a coldest point at an end of an arc tube toward a discharge light emitting chamber, thereby preventing a decrease in an amount of a metal halide that contributes to discharge light emission.

In accordance with one or more embodiments of the present invention, in a first aspect, a discharge bulb is provided with: a ceramic arc tube; a discharge light emitting chamber formed at a substantially center of a longitudinal direction of the ceramic arc tube, wherein a luminescent material and a starting rare gas are filled in the discharge light emitting chamber; a metallic pipe provided in a pore, wherein the pore is formed in an end of the ceramic arc tube and communicates with the discharge light emitting chamber; an electrode rod, wherein a rear end of the electrode rod is inserted into the metallic pipe and a tip of the electrode rod protrudes into the discharge light emitting chamber; and a recess circumferentially arranged on an inner peripheral surface of the pore between a tip of the metallic pipe and an opening edge of the pore on a side of the discharge light emitting chamber.

(Working effect) A metallic pipe and an electrode rod have good thermal conductivity (hear radiation). Thus, the coldest point of an illuminating arc tube (coldest point in the communicating part of the discharge light emitting chamber) is generally inward from a micro-space between the electrode rod as the end of the arc tube and the metallic pipe (most distant area from the discharge light emitting chamber or at the end of the ceramic tube). The metallic pipe with good thermal conductivity is not inserted as far as the opening position of the pore to the discharge light emitting chamber and a recess is circumferentially arranged on the inner peripheral surface between the tip of the metallic pipe and the discharge light emitting chamber. Thus, heat transmitted by way of the metallic part and radiant heat of the electrode rod are hard to be transmitted to the recess, so that the recess is the coldest point. In other words, the coldest point in the arc tube has moved from the end of the arc tube toward the discharge light emitting chamber.

As a result, the metal halide filled in the discharge light emitting chamber may be retained (gathered) in the recess as the coldest point but is never retained (gathered) in the micro-space between the electrode rod and the metallic pipe unlike in the related art structure. The space where the recess is formed is sufficiently wider than the micro-space between the electrode rod and the metallic pipe and closer to the discharge light emitting chamber. Thus, the vaporous, liquid or solid metal halide gathered in the recess smoothly moves into a high-temperature discharge light emitting chamber so that it does not stay in the recess.

Further, in a second aspect, a joint between a region of the metallic pipe protruding from the ceramic tube and the electrode rod may be covered with a heat insulator.

A heat insulator covering the joint between the region of the metallic pipe protruding from the ceramic tube and the electrode rod may be a ceramic cap integrally stuck to the joint between the region of the metallic pipe protruding from the ceramic tube or a heat insulating film of ceramics (alumina) coated on the joint between the region of the metallic pipe protruding from the ceramic tube.

(Working effect) The amount of heat from the arc tube covered with an insulator (joint between the metallic pipe and the electrode rod) decreases and the coldest point in the arc tube moves toward the discharge light emitting chamber and it is assured that the coldest point is in the recess. That is, the coldest point in the arc tube has reliably moved toward the discharge light emitting chamber.

In a third aspect of the invention, the discharge bulb is provided with: an arc tube; a discharge light emitting chamber formed at a substantially center of a longitudinal direction of the arc tube, wherein a luminescent material and a starting rare gas are filled in the discharge light emitting chamber; an electrode rod inserted into a pore, wherein the pore is formed in an end of the arc tube and communicates with the discharge light emitting chamber, a tip of the electrode rod protrudes into the discharge light emitting chamber, and a rear end of the electrode rod is jointed to a periphery of an outer opening of the pore; and a recess circumferentially arranged on an inner peripheral surface of the pore close to the discharge light emitting chamber.

(Working effect) An electrode rod has good thermal conductivity (hear radiation). Thus, the coldest point of an illuminating arc tube (coldest point in the communicating part of the discharge light emitting chamber) is generally inward from a micro-space between the pore as the end of the arc tube and the electrode rod (most distant area from the discharge light emitting chamber or at the end of the ceramic tube). A recess is circumferentially arranged on the inner peripheral surface of the pore. The radiant heat is hard to be transmitted into the recess which is located farther from the electrode rod, thus the recess is the coldest point. That is, the coldest point in the arc tube has moved from the end of the arc tube toward the discharge light emitting chamber.

As a result, the metal halide filled in the discharge light emitting chamber is may be retained (gathered) in the recess as the coldest point but is never retained (gathered) in the micro-space between the pore and the electrode rod. The space where the recess is formed is close to the discharge light emitting chamber. Thus, the vaporous, liquid or solid metal halide gathered in the recess smoothly moves into a high-temperature discharge light emitting chamber so that it does not stay in the recess.

In a fourth aspect of the invention, the electrode rode may include a tungsten electrode rod with a small diameter on the tip side a molybdenum rod with a large diameter on the rear side, and the tungsten electrode rod is coaxially welded to the molybdenum rod, and the recess may be arranged in close proximity to a welded part of the tungsten electrode rod and the molybdenum rod.

(Working effect) The temperature in the recess as the coldest point in the arc tube drops as the recess is positioned closer to the end of the arc tube (distant from the discharge light emitting chamber at a high temperature) with good heat radiation. Thus, the recess should be placed away from the discharge light emitting chamber to some degree. The space between the pore and the tungsten electrode rod is wider than the space between the pore and the molybdenum rod and closer to the discharge light emitting chamber. This smoothly expels the metal halide gathered, if any, into the discharge light emitting chamber. By arranging a recess in close proximity to the welded part between the tungsten electrode rod and the molybdenum rod, it is ensured that the coldest point in the arc tube is in the recess. In case the fourth aspect is applied to the first or second aspect, gathering of a metal halide in the space between the molybdenum rod and the metallic pipe is further suppressed. In case the fourth aspect is applied to the third aspect, gathering of metal halide in the space between the molybdenum rod and the pore is further suppressed.

According to the discharge bulb of the first aspect, the coldest point in the arc tube moves into the recess on the inner peripheral surface provided close to the discharge light emitting chamber. Metal halide no longer gathers in the micro-space between the electrode rod and the metallic pipe and the amount of metal halide contributing to discharge light emission does not decrease. This assures a desired luminous flux for a long time.

According to the second aspect, heat radiation at the end of the arc tube is suppressed. The coldest point in the arc tube reliably moves into a recess arranged close to the discharge light emitting chamber, which further prevents gathering of a filled metal halide in the micro-space between the electrode rod and the metallic pipe and corresponding decrease in the amount of metal halide contributing to discharge light emission. This assures a desired luminous flux for a longer time.

According to the discharge bulb of the third aspect, the coldest point in the arc tube moves into the recess on the inner peripheral surface provided close to the discharge light emitting chamber. Metal halide no longer gathers in the micro-space between the electrode rod and the pore and the amount of metal halide contributing to discharge light emission does not decrease. This assures a desired luminous flux for a long time.

According to the fourth aspect, it is assured that the coldest point in the arc tube is in the recess. This further prevents gathering of a filled metal halide in the micro-space around the base end of the electrode rod and corresponding decrease in the amount of metal halide contributing to discharge light emission. This assures a desired luminous flux for a longer time.

Other aspects and advantages of the invention will be apparent from the following description and the appended claims.

### BRIEF DESCRIPTION OF THE DRAWINGS

FIG. 1 is a front view of an automobile headlamp that uses as a light source a discharge bulb of a first exemplary embodiment.

FIG. 2 shows a longitudinal cross-section in vertical direction of the headlamp taken along the line II—II in FIG. 1.

FIG. 3 shows an enlarged longitudinal cross-section in vertical direction of an arc tube as a key part of the discharge bulb.

FIG. 4 shows a transverse cross-section in vertical direction of the arc tube taken along the line IV—IV in FIG. 3.

FIG. 5 shows an enlarged longitudinal cross-section in vertical direction of the arc tube main unit.

FIG. 6 shows a longitudinal cross-section in vertical direction of an arc tube main unit as a key part of a discharge bulb of a second exemplary embodiment.

FIG. 7 shows a longitudinal cross-section in vertical direction of an arc tube main unit as a key part of a discharge bulb of a third exemplary embodiment.

FIG. 8 shows a longitudinal cross-section in vertical direction of an arc tube main unit as a key part of a discharge bulb of a fourth exemplary embodiment.

FIG. 9 shows a longitudinal cross-section in vertical direction of an arc tube main unit as a key part of a related art discharge bulb.

FIG. 10 shows a longitudinal cross-section in vertical direction of an arc tube main unit contemplated by the inventor.

### DETAILED DESCRIPTION OF THE EXEMPLARY EMBODIMENTS

Exemplary embodiments of the invention will be described with reference to the accompanying drawings.

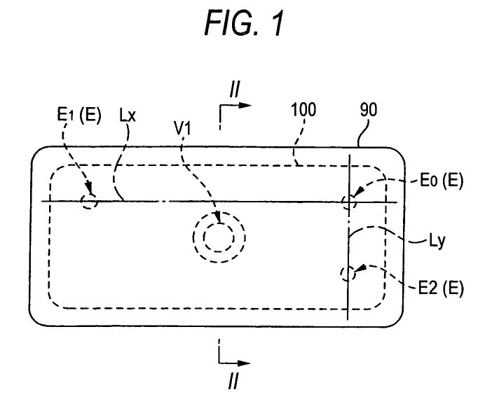

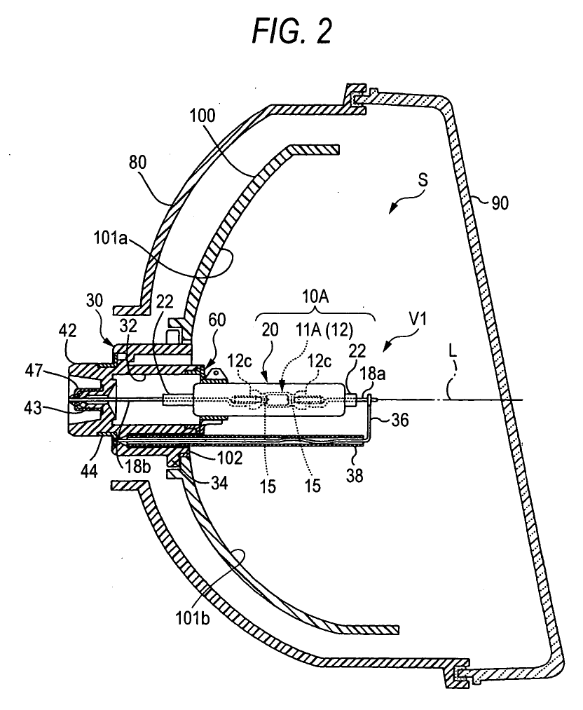

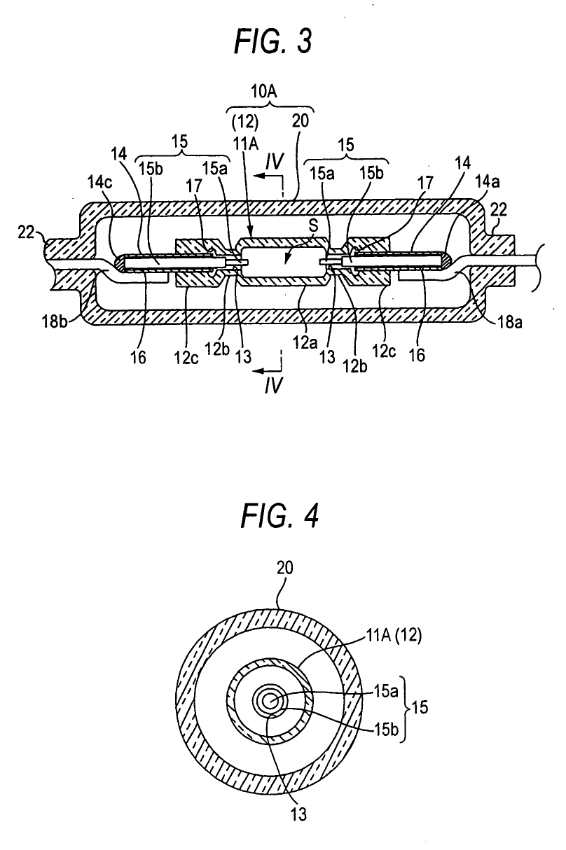

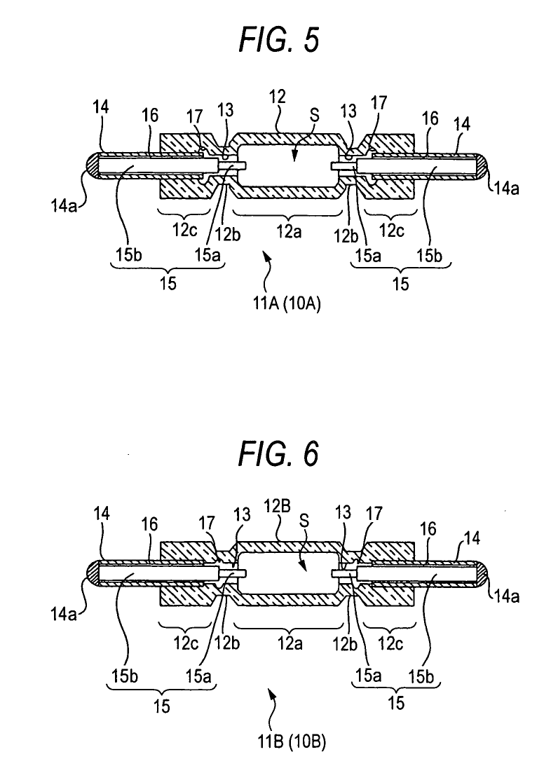

FIGS. 1 through 5 show the first exemplary embodiment of the invention. FIG. 1 is a front view of an automobile headlamp that uses as a light source a discharge bulb. FIG. 2 shows a longitudinal cross-section in vertical direction of the headlamp taken along the line II—II in FIG. 1. FIG. 3 shows an enlarged longitudinal cross-section in vertical direction of an arc tube as a key part of the discharge bulb. FIG. 4 shows a transverse cross-section of the arc tube taken along the line IV—IV in FIG. 3. FIG. 5 shows an enlarged longitudinal cross-section in vertical direction of the arc tube main unit.

In these figures, a sign 80 represents the container-shaped lamp body of the automobile headlamp whose front side opens. To the front opening of the lamp body is assembled a transparent front cover 90 to partition a lamp chamber S. In the lamp chamber S is housed a reflector 100 with a discharge bulb V1 inserted into a bulb insert hole 102 at the rear apex. Inside the reflector 100, effective reflecting surfaces 101a, 101b that are aluminum-evaporated are formed. The effective reflective faces 101a, 101b are composed of multiple light distribution steps (multiple reflecting surfaces) having different curved surface shapes. Light emitted from the bulb V1 is reflected on (the effective reflecting surfaces 101a and 101b of) the reflector 100 and irradiated forward to form a predetermined light distribution pattern of the headlamp.

As shown in FIG. 1, between the reflector 100 and the lamp body 80, an aiming fulcrum E0 of a single ball-joint structure and an aiming mechanism E composed of two aiming screws E1, E2 are interposed, so as to tilt the optical axis L of the reflector 100 (headlamp) about a horizontal tilting axis Lx and vertical tilting axis Ly, that is, make aiming adjustment of the optical axis L of the headlamp.

A sign 30 represents an insulating base composed of a PPS resin. On the periphery of the insulating base, a focus ring 34 engaged with the bulb insert hole 102 of the reflector 100 is arranged. In the forward direction of the insulating base 30, an arc tube 10A is fixed and supported by a metallic lead support 36 as an energizing path extending forward from the base 30, and a metallic support member 60 fixed to the front surface of the base 30 to constitute a discharge bulb V1.

That is, a read wire 18a guided from the front end of the arc tube 10A is fixed by spot welding to the bent tip of the lead support 36 extending from the insulating base 30 so that the front end of the arc tube 10A is supported by the bent tip of the lead support 36. On the other hand, a read wire 18b guided from the rear end of the arc tube 10A is connected to a terminal 47 arranged at the rear end of the base 30. The rear end of the arc tube 10A is grasped by a metallic support member 60 fixed to the front surface of the insulating base 30.

At the front end of the insulating base 30, a recess 32 is arranged. In the recess 32, the rear end of the arc tube 10A is housed and retained. At the rear end of the insulating base 30, a cylindrical boss 43 is formed. The cylindrical boss 43 is enclosed by a cylindrical outer casing 42 extending rearward. On the outer periphery of the root part of the outer casing 42, a cylindrical belt terminal 44 connected to the lead support 36 is integrally fixed. To the boss 43, a cap terminal 47 is integrally stuck. To the cap terminal 47, the rear lead wire 18b is connected.

As shown in FIG. 3, the arc tube 10A is composed of an arc tube main unit 11A including a discharge light emitting chamber s in which rod-shaped electrodes 15, 15 are provided face to face and a luminescent material such as a metal halide is filled together with a starting rare gas. A cylinder-shaped shroud glass 20 for shielding ultraviolet rays covering the arc tube main unit 11A is integrated with the arc tube main unit 11A. From the front/rear end of the arc tube main unit 11A, lead wires 18a, 18b are guided. The lead wires 18a, 18b are electrically connected to the rod-shaped electrodes 15, 15 protruding into the discharge light emitting chamber s. The shroud glass 20 for shielding ultraviolet rays is sealed to the lead wires 18a, 18b to integrate the arc tube main unit 11A and the shroud glass 20. A sign 22 represents a sealed part of the shroud glass 20 of which the diameter is contracted.

The arc tube main unit 11A is composed of a cylindrical transparent ceramic tube 12. At the center of the ceramic tube 12 in longitudinal direction, a discharge light emitting part 12a is formed to partition a discharge light emitting chamber s. At each end 12c of the ceramic tube 12 separated by a constricted part 12b, a pore 13 is formed. The pore 13 is communicating with the discharge light emitting chamber s of the discharge light emitting part 12a.

Near the opening at the end of the pore 13, a molybdenum pipe is fixed by metallization jointing. From the end of the ceramic tube 12, the molybdenum pipe 14 protrudes. The rod-shaped electrode 15 is inserted into the molybdenum pipe 14. A tip of the rod-shaped electrode 15 protrudes into the discharge light emitting chamber s. A rear end of rod-shaped electrode 15 is welded (jointed) to the protruding tip of the molybdenum pipe 14 so as to be integral with the ceramic tube 12. A pore 13 communicating with the discharge light emitting chamber s. In the discharge light emitting chamber s, a luminescent material such as a metal halide is filled together with a starting rare gas is sealed. A sign 14a represents a laser welded part.

The rod-shaped electrode 15 is made of a tungsten electrode rod 15a with a small diameter and a molybdenum rod 15b with a large diameter. The tungsten electrode rod 15a and the molybdenum rod 15b are coaxially and integrally jointed. The tungsten electrode rod 15a is disposed in the tip side of the rod-shaped electrode 15. The molybdenum rod 15b is disposed in the rear side of the rod-shaped electrode 15. Between the molybdenum pipe 14 and the molybdenum rod 15b of the rod-shaped electrode 15, a micro-space 16 of for example about 25 micrometers is formed so as to allow insertion of the rod-shaped electrode 15 and absorb the thermal stress generated at both ends of the ceramic tube 12. To the molybdenum pipe 14 protruding from the ceramic tube 12, the bent tip parts of the lead wires 18a, 18b are fixed. The lead wires 18a, 18b and the rod-shaped electrodes 15, 15 are arranged on the same axis (refer to FIGS. 3, 5).

In a position on the inner peripheral surface of the pore 13 formed at each end of the ceramic tube 12 in close proximity to the inserting tip of the molybdenum pipe 14, is circumferentially arranged a recessed groove 17 as a recess for preventing gathering of a metal halide filled in the discharge light emitting chamber s inside the micro-space 16 between the molybdenum pipe 14 and the rod-shaped electrode 15 and suppressing reduction in the amount of the metal halide substantially contributing to discharge light emission.

The molybdenum pipe 14 and the rod-shaped electrode 15 have good thermal conductivity (heat radiation). Thus, the coldest point in the illuminating arc tube 11A (coldest point in the communicating part of the discharge light emitting chamber s) is generally inward from the micro-space 16 between the rod-shaped electrode 15 and the molybdenum pipe 14 (most distant area from the discharge light emitting chamber s or end of the ceramic tube 12). The molybdenum pipe 14 with good thermal conductivity is not inserted as far as the opening position of the pore 13 to the discharge light emitting chamber s and the recessed groove 17 is circumferentially arranged on the inner peripheral surface of the pore 13 in close proximity to the tip of the molybdenum pipe 14. Thus, heat transmitted by way of the molybdenum pipe 14 and radiant heat of the rod-shaped electrode 15 are hard to be transmitted to the recessed groove 17, so that the recessed groove 17 is the coldest point. In other words, the coldest point in the arc tube 10A has moved from the end of the arc tube 10A into the recessed groove 17 close to the discharge light emitting chamber s.

As a result, the metal halide filled in the discharge light emitting chamber s may be retained (gathered) in the recessed groove 17 as the coldest point but is never retained (gathered) in the micro-space 16 between the rod-shaped electrode 15 and the molybdenum pipe 14 unlike in the related art structure. The space where the recessed groove 17 is formed (space between the rod-shaped electrode 15 and the pore 13) is sufficiently wider than the micro-space 16 between the rod-shaped electrode and the molybdenum pipe and closer to the discharge light emitting chamber s. Thus, the vaporous, liquid or solid metal halide gathered in the recessed groove 17 smoothly moves into a high-temperature discharge light emitting chamber s so that it does not stay in the recess.

Thus, according to (the arc tube main unit 11A of) the discharge bulb of the present exemplary embodiment, the amount of a metal halide contributing to discharge light emission does not decrease even after prolonged use, thereby assuring a desired luminous flux for a long time.

The narrower the micro-space 16 is, the filled metal halide is difficult to invade the micro-space 16. This is preferable although there is a manufacturing error concerning the outer diameter of (the pore 13 of) the ceramic tube 12 and that of the rod-shaped electrode 15 so that the micro-space 16 cannot be reduced to 20 micrometer or smaller.

FIG. 6 shows a longitudinal cross-section in vertical direction of an arc tube main unit as a key part of the discharge bulb of the second exemplary embodiment of the invention.

While in the first exemplary embodiment, the recessed groove 17 as the coldest point in the arc tube main unit 11A (ceramic tube 12) is arranged on the inner peripheral surface of the pore 13 in close proximity to the tip of the molybdenum pipe 14, in the second embodiment, the recessed groove 17 as the coldest point in the arc tube main unit 11B (ceramic tube 12B) is arranged in close proximity to the joint between the tungsten electrode rod 15a with a small diameter on the tip side and the molybdenum rod 15b with a large diameter on the base end side that is closer to the discharge light emitting chamber s than the tip of the molybdenum pipe 14.

Thus, the space between the pore 13 to which the recessed groove 17 opens and the tungsten electrode rod 15a is larger than the space between the pore 13 and the molybdenum rod 15b and closer to the discharge light emitting chamber s. Thus, the metal halide is more difficult to be gathered in the micro-space 16. The metal halide is gathered in the recessed groove 17 as the coldest point, if any, moves smoother to the discharge light emitting chamber S than that in the first embodiment. This results in smaller variations in the luminous flux while the arc tube is illuminating.

The other parts are same as those in the first exemplary embodiment. They are given the same signs and corresponding description is omitted.

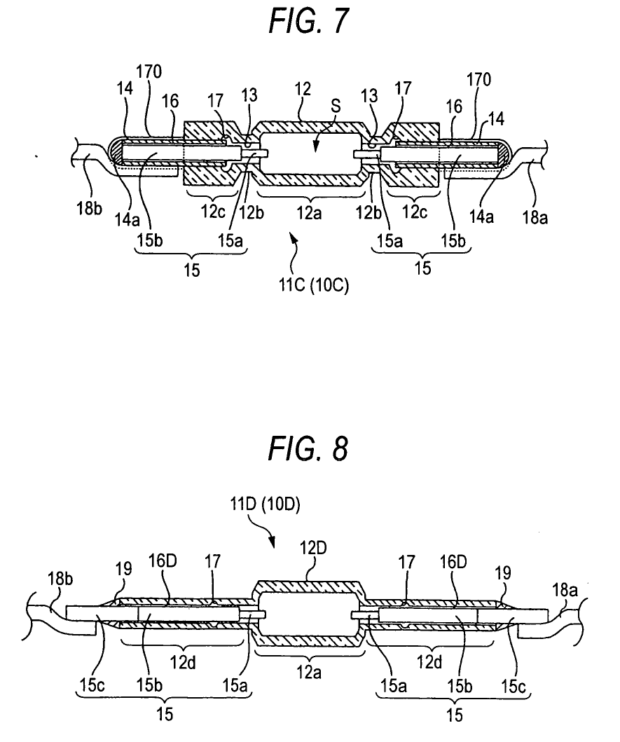

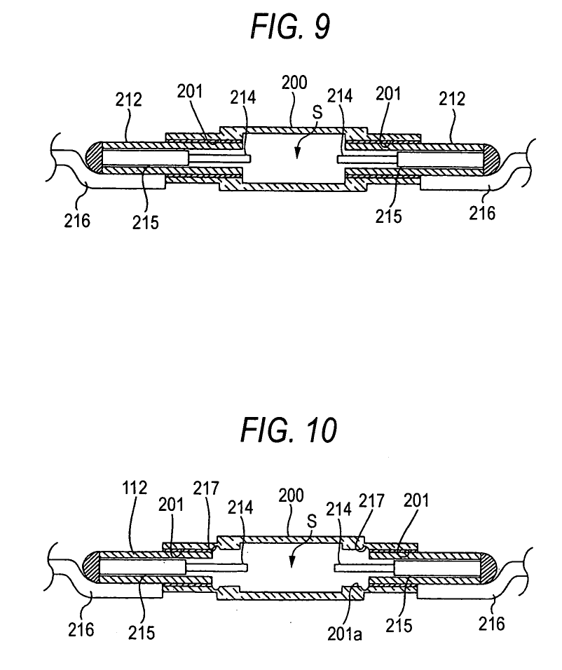

FIG. 7 shows a longitudinal cross-section in vertical direction of an arc tube main unit as a key part of the discharge bulb of the third exemplary embodiment of the invention.

According to the arc tube main unit 11C of the third exemplary embodiment, a ceramic heat insulating cap 170 is integrally stuck to the molybdenum pipe protruding from the end 12c of the arc tube 11A (ceramic tube 12) according to the first exemplary embodiment and the welded part 14a. It is thus assured that the coldest point at the end of the arc tube main unit 11C has moved into the recess 17 on the inner peripheral surface of the pore 13 close to the discharge light emitting chamber s. This further suppresses gathering of a metal halide in the micro-space 16 between the molybdenum pipe 14 and the rod-shaped electrode 15 and assures a desired luminous flux for a long time.

That is, the amount of heat radiation from the molybdenum pipe 14 and the welded part 14a covered by the heat insulating cap 170 is reduced. The end 12c of the ceramic tube 12C is filled with heat and movement of the coldest point at the end of the arc tube main unit 11C toward the discharge light emitting chamber s is accelerated. It is thus assured that the coldest point at the end of the arc tube main unit 11C has moved into the recessed groove 17 on the inner peripheral surface of the pore 13. This further suppresses gathering of a metal halide in the micro-space 16 between the molybdenum pipe 14 and the rod-shaped electrode 15 than the first and second exemplary embodiments.

In the third exemplary embodiment, instead of using the ceramic heat insulating cap 170, a heat insulating film of ceramics (alumina) may be coated on the region and the welded part 14a of the molybdenum pipe 14 protruding from the ceramic tube 12.

FIG. 8 shows a longitudinal cross-section in vertical direction of an arc tube main unit as a key part of the discharge bulb of a fourth exemplary embodiment of the invention.

While the rod-shaped electrode 12 is integrally jointed to the ceramic tube 12 (12B, 12C) via the molybdenum pipe 12 jointed by metallization to the pore 13 of the ceramic tube 12 (12B, 12C), the rod-shaped electrode 15 is integrally jointed to the ceramic tube 12D directly by way of frit seal.

The ceramic tube 12C constituting the arc tube main unit 11C has a cylindrical shape overall, same as the ceramic tube 12 (12B, 12C) according to the first through third exemplary embodiments except that a ceramic tube end 12d with a smaller outer diameter than that of the discharge light emitting part 12a is formed at each end of the discharge light emitting part 12a at the center in the longitudinal direction. The rod-shaped electrode 15 has its base end composed of a joint body of a molybdenum rode 15b and a niobium rod 15c. In the ceramic tube end 12d is formed a pore 13 communicating with the discharge light emitting chamber s of the discharge light emitting part 12a.

The rod-shaped electrode 15 inserted into the pore 13 so that the tungsten electrode rod 15a at its tip will protrude into the discharge light emitting chamber s has its rear end niobium rod 15c substantially protruding from the ceramic tube end 12d and integrated with the end face of the ceramic tube end 12d by glass welding. A sign 19 represents a glass welded part. The protruding end from the ceramic tube end 12d of the rod-shaped electrode 15 (niobium rod 15c) is jointed to the bent parts of the lead wires 18a, 18b and the ceramic tube 12C and the lead wires 18a, 18b are extended on the same axis.

Between the rod-shaped electrode 15 composed of the tungsten electrode rod 15a with a small diameter at the tip, a molybdenum rode 15b with a large diameter at the base end and the niobium rod 15c integrally jointed together and the pore 13 of the ceramic tube end 12d is formed a micro-space 16C of for example about 25 micrometers so as to allow insertion of the rod-shaped electrode 15 and absorb the thermal stress generated at both ends 12d of the ceramic tube 12d.

In a position on the inner peripheral surface of the pore 13 formed at the ceramic tube end 12d in close proximity to the joint between the tungsten electrode rod 15a and the molybdenum rod 15b is circumferentially arranged a recessed groove 17 as a recess for preventing gathering of a metal halide filled in the discharge light emitting chamber s inside the micro-space 16C between the pore 13 and the molybdenum rod 15b and suppressing reduction in the amount of the metal halide substantially contributing to discharge light emission.

The rod-shaped electrode 15 has good thermal conductivity (heat radiation). Thus, the coldest point in the illuminating arc tube 11D (coldest point in the communicating part of the discharge light emitting chamber s) is generally inward from the micro-space 16D between the pore 13 as the end of the ceramic tube 11D and the rod-shaped electrode 15 (most distant area from the discharge light emitting chamber s or end of the ceramic tube 12D). The recessed groove 17 is circumferentially arranged on the inner peripheral surface of the pore 13 close to the discharge light emitting chamber s. The recessed groove 17 is located away from the rod-shaped electrode 15 so that the radiant heat of (the tungsten electrode rod 15a) of the rod-shaped electrode 15 is hard to be transmitted to the recessed groove 17. Thus, the recessed groove 17 is the coldest point. In other words, the coldest point in the arc tube main unit 11D has moved from the end of the arc tube main unit 11D toward the discharge light emitting chamber s.

As a result, the metal halide filled in the discharge light emitting chamber s may be retained (gathered) in the recess 17 as the coldest point but is never retained (gathered) in the micro-space 16D between the pore 13 and the rod-shaped electrode 15. The space where the recessed groove 17 is formed is sufficiently wider than the micro-space 16D between the molybdenum rid 15b and the pore 13 and closer to the discharge light emitting chamber s. Thus, the vaporous, liquid or solid metal halide gathered in the recessed groove 17 smoothly moves into a high-temperature discharge light emitting chamber s so that it does not stay in the recessed groove 17. The other parts are substantially the same as those in the first exemplary embodiment. They are given the same signs and corresponding description is omitted.

In this way, according to (the arc tube main unit 11D of) the discharge bulb shown in the fourth embodiment also, substantially the same as (the arc tube main units 11A, 11B, 11C of) the discharge bulb according to the first through third exemplary embodiments, the amount of a metal halide contributing to discharge light emission does not decrease even after prolonged use, thereby assuring a desired luminous flux for a long time.

While each of the arc tubes 10A through 10D in the exemplary embodiments has a structure where the ceramic arc tube main units 11A through 11D and the shroud glass 20 enclosing the arc tube main units 11A through 11D are integrated together before the insulating base 30, the arc tube main units 11A through 11D arranged before the insulating base 30 may be the ceramic arc tube main units 11A through 11D without the shroud glass 20.

It will be apparent to those skilled in the art that various modifications and variations can be made to the described exemplary embodiments of the present invention without departing from the spirit or scope of the invention. Thus, it is intended that the present invention cover all modifications and variation of this invention consistent with the scope of the appended claims and their equivalents.

What is claimed is:

1. A discharge bulb comprising:
a ceramic arc tube;
a discharge light emitting chamber formed at a substantially center of a longitudinal direction of the ceramic arc tube, wherein a luminescent material and a starting rare gas are filled in the discharge light emitting chamber;
a metallic pipe provided in a pore, wherein the pore is formed in an end of the ceramic arc tube and communicates with the discharge light emitting chamber;
an electrode rod, wherein a rear end of the electrode rod is inserted into the metallic pipe and a tip of the electrode rod protrudes into the discharge light emitting chamber; and
a recess circumferentially arranged on an inner peripheral surface of the pore between a tip of the metallic pipe and an opening edge of the pore on a side of the discharge light emitting chamber.

2. The discharge bulb according to claim 1, wherein a joint between a region of the metallic pipe protruding from the ceramic tube and the electrode rod is covered with a heat insulator.

3. The discharge bulb according to claim 1, wherein the electrode rode includes a tungsten electrode rod with a small diameter on the tip side a molybdenum rod with a large diameter on the rear side, and the tungsten electrode rod is coaxially welded to the molybdenum rod, and
the recess is arranged in close proximity to a welded part of the tungsten electrode rod and the molybdenum rod.

4. A discharge bulb comprising:
an arc tube;
a discharge light emitting chamber formed at a substantially center of a longitudinal direction of the arc tube, wherein a luminescent material and a starting rare gas are filled in the discharge light emitting chamber;
an electrode rod inserted into a pore, wherein the pore is formed in an end of the arc tube and communicates with the discharge light emitting chamber, a tip of the electrode rod protrudes into the discharge light emitting chamber, and a rear end of the electrode rod is jointed to a periphery of an outer opening of the pore; and
a recess circumferentially arranged on an inner peripheral surface of the pore close to the discharge light emitting chamber.

5. The discharge bulb according to claim 4, wherein the electrode rode includes a tungsten electrode rod with a small diameter on the tip side a molybdenum rod with a large diameter on the rear side, and the tungsten electrode rod is coaxially welded to the molybdenum rod, and
the recess is arranged in close proximity to a welded part of the tungsten electrode rod and the molybdenum rod.
